(19) United States
(12) Patent Application Publication
(10) Pub. No.: US 2002/0180200 A1
(43) Pub. Date: Dec. 5, 2002

(54) Seat belt apparatus

(75) Inventor: Osamu Tokugawa, Kanagawa (JP)

Correspondence Address: Sughrue Mion, PLLC, 2100 Pennsylvania Avenue, NW, Washington, DC, 20037-3213, US

(73) Assignee: NSK AUTOLIV CO., LTD

(21) Appl. No.: 10/158,994

(22) Filed: Jun. 3, 2002

(30) Foreign Application Priority Data
Jun. 4, 2001 (JP) P. 2001-168007

(51) Int. Cl. B60R 22/00

(52) U.S. Cl. 280/801.1

(57) ABSTRACT

The seat belt apparatus comprises a tongue plate, a buckle base structured such that the tongue plate can be inserted thereinto and removed therefrom, and a switch disposed on the buckle base for detecting the engaged and removed of the tongue plate. The switch is fixed to the buckle base by a rivet.

The present invention relates to a seat belt apparatus to be disposed in the seat of a vehicle such as a car.

Conventionally, in the seat of a vehicle such as a car, in order to secure the safety of an occupant, there is disposed a seat belt apparatus. This seat belt apparatus includes a buckle device which is used to removably lock a webbing provided on the seat.

The buckle device of this type, generally, comprises a tongue plate through which a webbing (belt) can be inserted, and a buckle main body for removably locking the tongue plate with the webbing inserted therethrough; and, the buckle device is disposed through an anchor on the floor or seat of the vehicle.

The buckle main body comprises a latch plate including a latch portion for locking the tongue plate, a buckle base for supporting the latch plate movably, a slider movable depending to the insertion and removal of the tongue plate to thereby move the latch plate, and a switch for detecting the engaged and removed states of the tongue plate with respect to the buckle main body.

As a buckle device of this type which is applied to a seat belt apparatus, for example, there are known buckle devices respectively disclosed in JP-UM-A-49-137225, U.S. Pat. No. 4,785,906 and JP-UM-A-2-143721.

A buckle device disclosed in JP-UM-A-49-137225 has the following structure: that is, two projections are provided on the bottom surface of a switch, the two projections are inserted into holes opened up in the bottom surface of a buckle base, and the two projections are then held by a cover, thereby mounting the switch on a buckle main body. The above switch is able to detect the engaged and removed states of the tongue plate with respect to the buckle main body in such a manner that a switch button is pressed down by the tongue plate inserted into the buckle main body.

Also, a buckle device disclosed in U.S. Pat. No. 4,785,906 has the following structure: that is, a switch is fixed to the bottom surface of a buckle base using a screw to thereby mount the present switch on a buckle main body. This switch can be operated through an ejector by a tongue plate inserted into the buckle main body.

Further, according to a buckle device disclosed in JP-UM-A-2-143721, a switch including a movable terminal serving as a striker is fixed to a buckle cover (lower cover), and a slider is disposed so as to be movable by a tongue plate inserted into a buckle main body; and, the striker and slider are connected together to thereby be able to operate the switch.

Also, in the present buckle device, since the harness of the switch is fixed in such a manner that it is guided by a plurality of boss portions respectively formed in the inner surface of the lower cover, even in case where the harness is pulled, the switch can be prevented from suffering from any load.

However, since the buckle device disclosed in JP-UM-A-49-137225 is assembled in such a manner that there are formed clearances respectively between the holes opened up in the bottom surface of the buckle base, switch and cover, there is a fear that these clearances can cause the position of the switch to be unstable. In case where the position of the switch is unstable, the operation performance of the switch can be ill influenced. By the way, the cover, in many cases, is made of resin. In the case of the cover made of resin, in case where the change with age of the resin gives rise to the occurrence of deformation and/or cracks in the cover, the position of the switch cannot be stable; and, depending on the degrees of the deformation and cracks, it can be difficult to hold the switch at a given position.

Also, in the buckle device disclosed in U.S. Pat. No. 4,785,906, since the switch is fixed to the bottom surface of the buckle base by a screw, the switch can be held at a given position; but, it is necessary to work the buckle base to thereby form threads therein for engagement of the screw, which increases the number of steps of working the parts of the buckle device.

In view of this, you may have an idea of using a tapping screw. However, the buckle base, which is required to have strength, normally obtains its strength through heat treatment; and, therefore, it is impossible to use the tapping screw. Also, when fixing the switch by a screw, in case where the fastening force of the screw increases, a compressive force to be applied onto the switch increases. Accordingly, the fastening force must be controlled sufficiently.

Further, in the buckle device disclosed in JP-UM-A-2-143721, since the switch is fixed to the lower cover, the step of connecting together the striker and slider must be executed in a blind state where the striker and slider cannot be observed visually. Therefore, it is difficult to confirm the connecting state of the striker and slider and there is also a fear that they cannot be connected together. And, the lower cover, to which the switch is fixed, is normally made of resin and, therefore, for the same reason as in the buckle device disclosed in JP-UM-A-49-137225, there is a fear that it is difficult to hold the switch at a given position. Moreover, the harness of the switch is fixed in such a manner that it is guided by the plurality of boss portions respectively formed in the inner surface of the lower cover. In this structure, however, even in case where the harness is caused to float up from the lower cover in the lower cover assembling step, it is difficult to grasp such floated state of the harness. By the way, in case where the lower cover is assembled while the harness floats up from the lower cover, there is a fear that, when the harness is pulled, some load can be applied to the switch. Also, there is a possibility that, when assembling together the upper and lower covers, the harness can be caught by and between the two covers.

### SUMMARY OF THE INVENTION

The present invention aims at eliminating the drawbacks found in the above-mentioned conventional seat belt apparatus. Accordingly, it is an object of the invention to provide a seat belt apparatus including a buckle device having a highly reliable switch mounting structure which can stably hold a switch at a given position, is easy to assemble and, even in case where a harness is pulled, can control a load to be applied to the switch.

In attaining the above object, according to a first aspect of the invention, there is provided a seat belt apparatus, comprising: a tongue plate; a buckle base into which the tongue plate can be removably inserted and also which is capable of removably locking the tongue plate inserted thereinto; and, a switch disposed on the buckle base for detecting the engaged and removed states of the tongue plate, wherein the switch is fixed to the buckle base by a rivet.

According to the buckle device of the seat belt apparatus having the above structure, normally, since the switch is fixed to the metal-made buckle base by the rivet, the switch can prevented from shifting out of position. Therefore, the switch can be held at a given position positively. Also, because the switch is fixed by the rivet, in the buckle base, there may be only formed a simple hole into which the rivet can be inserted, so that the buckle base is simple to work.

As the above-mentioned rivet, there can be employed a blind rivet. In case where a blind rivet is employed, the blind rivet can be caulked from one direction and a load necessary for caulking can be made stable.

Also, the rivet may also be formed of aluminum. That is, in case where aluminum is employed as the material for forming the rivet, a compressive load to be applied to the switch can also be reduced.

The switch may also include a holding portion for holding a harness included in the switch and a guide portion for guiding the present harness. According to this structure, since the harness is fixed to the switch, the harness can be fixed before the buckle covers are assembled together. Also, because the arrangement passage (guiding passage) of the harness can be restricted, setting of a harness escape portion to be disposed in the buckle covers can be facilitated. Therefore, the buckle covers can be assembled together with no fear that the harness can be floated up or removed from the lower buckle cover as well as with no fear that the harness can be caught by and between the buckle covers.

Also, the hold portion and guide portion can be disposed at such positions as to allow the harness to be arranged at a given angle with respect to a direction in which the harness is pulled out from the buckle device. More preferably, the hold portion and guide portion may be disposed at such positions as to allow the harness to be arranged at substantially right angle to a direction in which the harness is pulled out from the buckle device. In case where the hold portion and guide portion are disposed in this manner, even when the harness is pulled unexpectedly, a load to be applied to the switch can be controlled.

Further, the guide portion may also be disposed in the vicinity of the harness exit of the buckle base and may include a curved surface. According to this structure, the curved surface can prevent the harness from being bent (folded) at an acute angle. Therefore, concentration of stresses on the harness can be relieved.

Also, according to a second aspect of the invention, there is provided a seat belt apparatus, comprising: a tongue plate; a buckle base into which the tongue plate can be removably inserted and also which is capable of removably locking the tongue plate inserted thereinto; and, a switch disposed on the buckle base for detecting the engaged and removed states of the tongue plate, wherein the switch comprises a hold portion for holding a harness of the switch and a guide portion for guiding the harness.

The hold portion and guide portion may be disposed at positions in which the harness is arranged at a given angle with respect to a direction in which the harness is pulled out from the buckle device. Also, the hold portion and guide portion may also be disposed at positions in which the harness is arranged at substantially right angle to a direction in which the harness is pulled out from the buckle device. Further, the guide portion may also be disposed in the vicinity of the harness exit of the buckle base and may include a curved surface.

The buckle device can also be mounted through a buckle stay onto a vehicle structured such that it can be rotated with respect to the buckle stay in the longitudinal direction and width direction of the vehicle.

### BRIEF DESCRIPTION OF THE DRAWINGS

FIG. 1 is a general view of a seat belt apparatus according to an embodiment 1 of the invention, showing a state in which it is actually used;

FIG. 2 is a longitudinal section view of a buckle device applied to the seat belt apparatus according to the embodiment 1 of the invention, showing a state in which a tongue plate is not inserted;

FIG. 3 is a bottom view of the buckle device shown in FIG. 2;

FIG. 4 is a longitudinal section view of a buckle device applied to the seat belt apparatus according to the embodiment 1 of the invention, showing a state in which a tongue plate is inserted;

FIG. 5 is a bottom view of the buckle device shown in FIG. 4;

FIG. 6 is plan and side views of the shape of the interior portion of a lower cover included in the above buckle device;

FIG. 7 is a bottom view of a switch and a harness, showing the state thereof when a lower cover is assembled to a buckle main body;

FIG. 8 is a section view of the neighboring portion of the switch;

FIG. 9 is a bottom view of FIG. 8;

FIG. 10 is a section view of the neighboring portion of a switch used in a seat belt apparatus according to an embodiment 2 of the invention;

FIG. 11 is a bottom view of FIG. 10;

FIG. 12 is a longitudinal section view of a buckle device applied to a seat belt apparatus according to an embodiment 3 of the invention, showing a state in which a tongue plate is inserted; and,

FIG. 13 is a bottom view of the buckle device shown in FIG. 12.

### DESCRIPTION OF THE PREFERRED ENBPDIMENTS

Next, description will be given below of the preferred embodiments of a seat belt apparatus according to the invention with reference to the accompanying drawings.

Embodiment 1

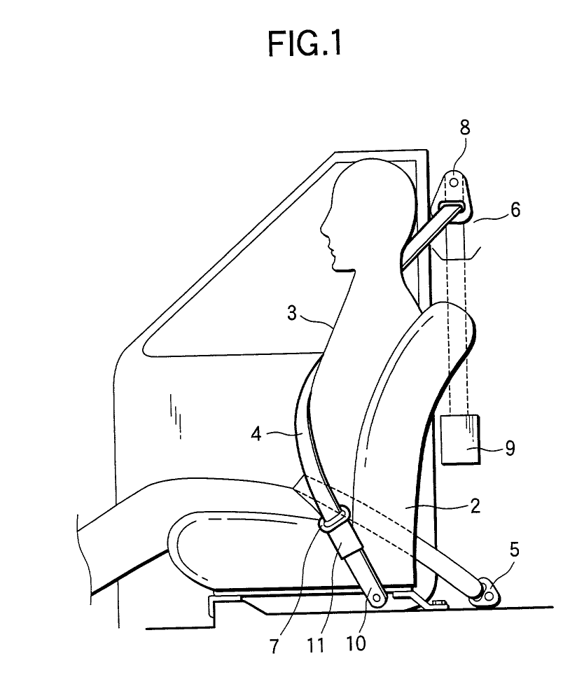

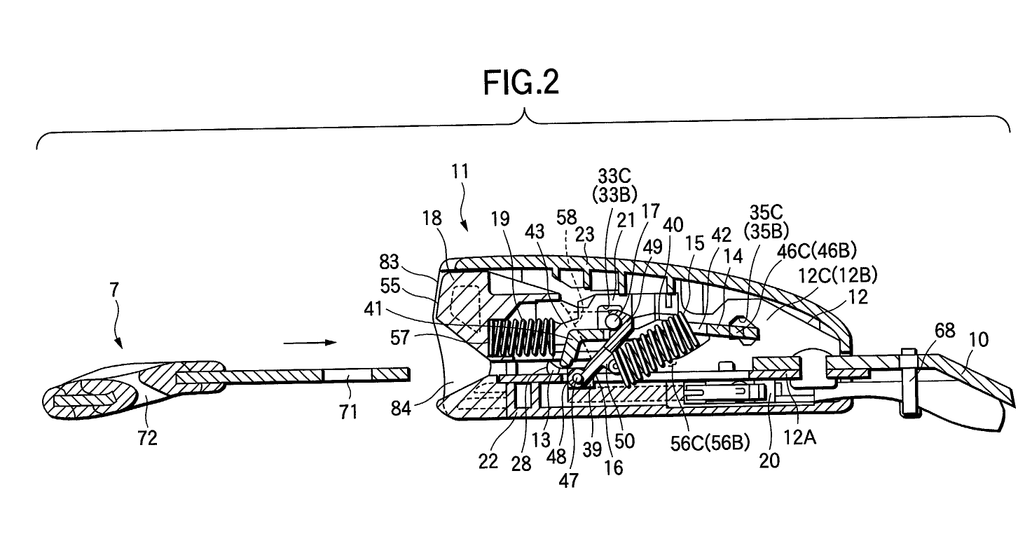

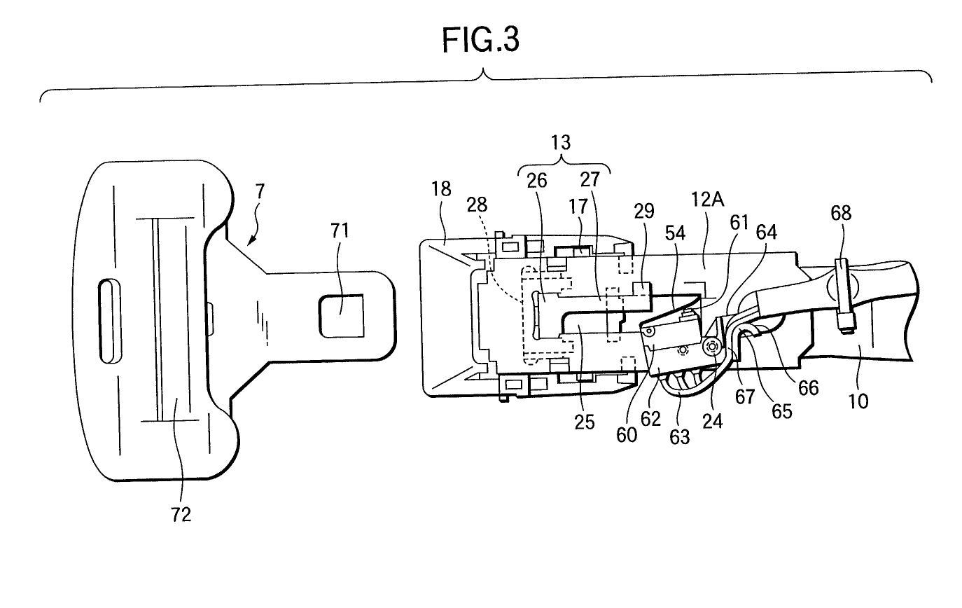

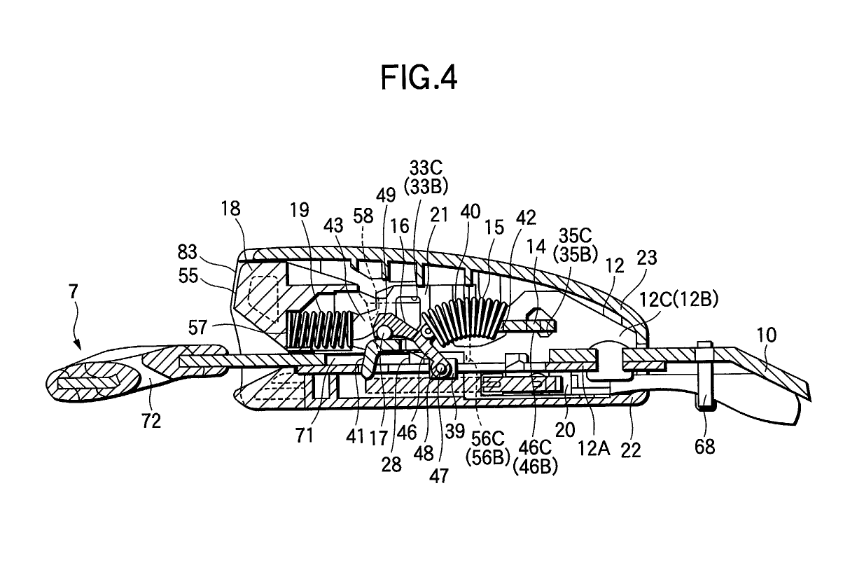

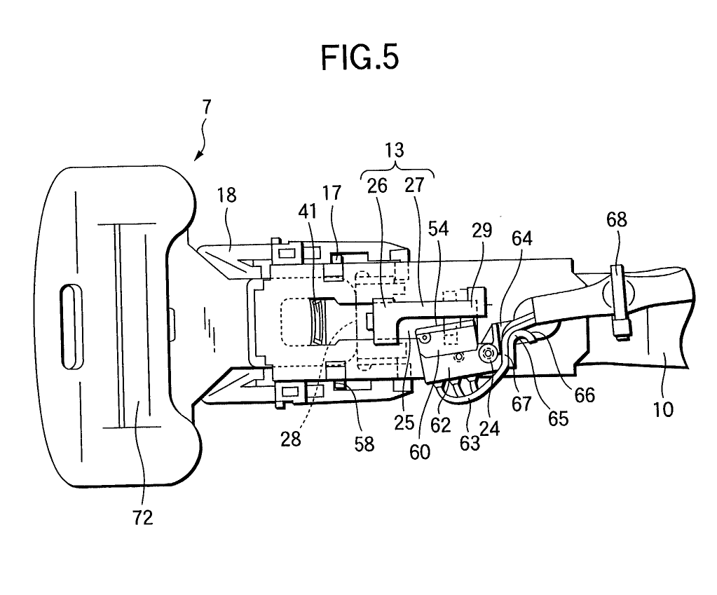

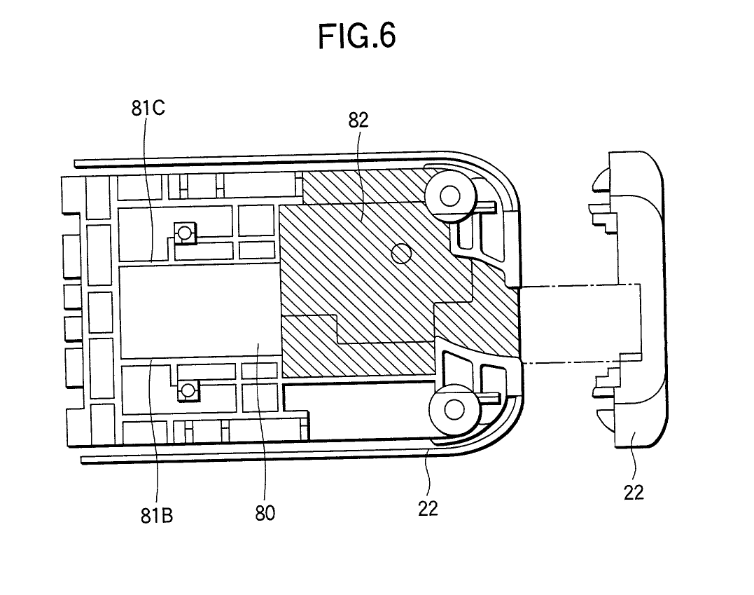

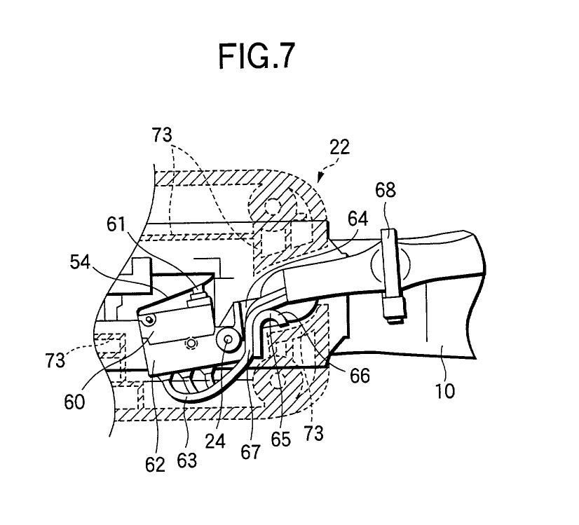

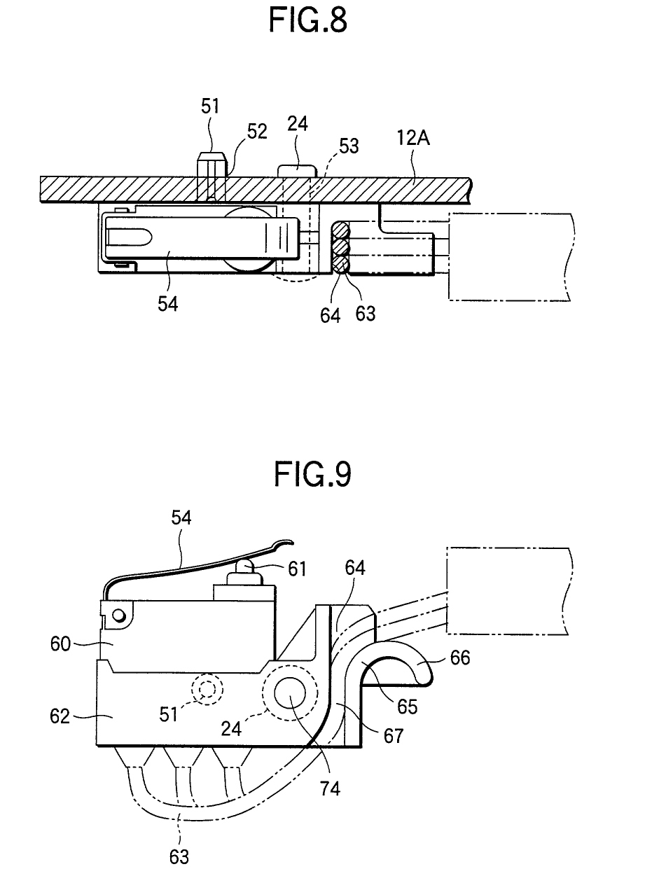

Now, FIG. 1 is a general view of a seat belt apparatus according to an embodiment 1 of the invention, showing a state in which it is actually used; FIG. 2 is a longitudinal section view of a buckle device applied to the seat belt apparatus according to the embodiment 1 of the invention, showing a state in which a tongue plate is not inserted; FIG. 3 is a bottom view of the buckle device shown in FIG. 2; FIG. 4 is a longitudinal section view of a buckle device applied to the seat belt apparatus according to the embodiment 1 of the invention, showing a state in which a tongue plate is inserted; FIG. 5 is a bottom view of the buckle device shown in FIG. 4; FIG. 6 is plan and side views of the shape of the interior portion of a lower cover included in the buckle device; FIG. 7 is a bottom view of a switch and a harness, showing the state thereof when a lower cover is assembled to a buckle main body; FIG. 8 is a section view of the neighboring portion of the switch; and, FIG. 9 is a bottom view of FIG. 8.

As shown in FIG. 1, a seat belt apparatus according to the embodiment 1 of the invention allows an occupant 3 seated on a seat 2 to put on a webbing (belt) 4. The webbing 4 is structured in the following manner: that is, one end of the webbing 4 is mounted on the lower portion of a vehicle side wall 6 by an anchor plate 5, the middle portion of the webbing 4 is movably inserted through an opening formed in a tongue plate 7 and is then turned back, and the other end side of the webbing 4 is taken up by an emergency-lock type take-up device 9 via a through ring 8 mounted on the upper portion of the vehicle side wall 6. Also, the leading end portion of the tongue plate 7 can be engaged with a buckle main body 11 disposed on the leading end portion of an anchor plate 10 which is mounted on the floor of the central portion of the vehicle or on the seat 2. By the way, in the embodiment 1, the tongue plate 7 and the buckle main body 11 for engaging and removing the tongue plate 7 cooperate together in constituting a buckle device.

As the tongue plate 7, there can be used a normal-type tongue plate for a seat belt. The tongue plate 7 includes a securing hole 71 formed in one end portion thereof and a belt connecting hole 72 formed in the other end portion thereof for connecting the webbing 4 to the tongue plate 7.

The buckle main body 11 comprises a buckle base 12 functioning as a frame, a slider 13 which can be moved in accordance with the insertion and removal of the tongue plate 7, a buckle arm 16 which can be oscillated in accordance with the movement of the slider 13, a coiled spring 15 which can be expanded and compressed in accordance with the oscillation of the buckle arm 16, a latch plate 14 for locking a tongue plate 7, a control pin 17 supported on the leading end portion of the buckle arm 16 for controlling the movement of the latch plate 14, a block member 21 disposed on the upper portion of the buckle base 12, a release button 18 for removing the locked condition of the tongue plate 7, a coiled spring 19 for energizing the release button 18 forwardly, a switch 20 fixed to the outer surface (back surface) of the bottom plate 12A of the buckle base 12 by a rivet 24, a lower cover 22 for covering these components from bottom, and an upper cover 23 for covering these components from above.

By the way, in the following description, with the buckle main body 11 shown in FIG. 2 as a standard, the left direction in FIG. 2, where a tongue plate insertion opening is present, is referred to as “the forward direction”, the right direction as “the rearward direction”, the upward direction as “the upward direction”, and the downward direction as “the downward direction”, respectively.

The buckle base 12, which is made of metal, is formed in a shape having a substantially U-shaped section; and, the buckle base 12 includes a bottom plate 12A and a pair of mutually opposed side walls 12B and 12C. In the bottom plate 12A, there is formed a slider guide hole 25 which allows the slider 13 to slide in the tongue plate inserting and removing direction. Also, in the portion of the bottom plate 12A that is present in the rear portion of the buckle base 12, there are opened up a hole 52 into which a boss 51 of the switch 20 can be inserted, and a hole 53 into which the rivet 24 can be inserted (the details of which will be discussed herein later).

In the substantially central portions of the side walls 12B and 12C, there are opened up substantially-L-shaped windows 33B and 33C by which the two ends of the control pin 17 can be movably supported. In the portions of the side walls 12B and 12C that are present in the rear of these windows 33B and 33C, there are formed support holes 35B and 35C by which support portions 46B and 46C serving as the fulcrums of oscillation (rotation) of the latch plate 14 can be rotatably supported, the details of the support portions 46B and 46C will be discussed later.

The slider 13 comprises a contact portion 26 with which the leading end of the tongue plate 7 inserted into the buckle main body 11 can be contacted, and an extension portion 27 which extends backwardly of the buckle base 12. The forward end face of the contact portion 26 provides a contact surface 28 with which the leading end of the tongue plate 7 can be contacted. On the other hand, the rearward end face of the extension portion 27 provides an operation foot portion 29 which shifts (operates) the actuator 54 (which will be discussed later) of the switch 20. Also, on the front side of the extension portion 27, there is formed a buckle arm storage portion 39 for storing the leading end of the buckle arm 16 (which will be discussed later). In the side wall of the buckle arm storage portion 39, there is formed a support hole 48 for supporting the two ends of a shaft portion 47 formed in the leading end portion of the buckle arm 16. In the present slider 13, the extension portion 27 is able to move downward (to the lower cover 22 side) through the slider guide hole 25 opened up in the bottom surface 12A and the contact portion 26 is able to slide on the bottom surface 12A (see FIG. 5).

Referring now to the structure of the buckle arm 16, in the upper end portion of the buckle arm 16, there is formed a hook-shaped support portion 49 for supporting the control pin 17 and, in the lower end portion of the buckle arm 16, there is formed a shaft portion 47 which can be supported in the support hole 48 of the buckle arm storage portion 39. The present buckle arm 16 can be rotated with the shaft portion 47 as its rotation shaft. On the rear side of the substantially central portion of the buckle arm 16, there is formed a spring support portion 50 by which one end of the coil spring 15 can be supported. The present buckle arm 16 is structured such that the support portion 49 is situated on the latch plate 14 and the portions of the buckle arm 16 existing downwardly of the support portion 49 are situated below the latch plate 14.

Now, in the substantially central portion of the latch plate 14, there is formed an opening 40 through which the buckle arm 16 can be in part penetrated. In the front end portion of the latch plate 14, there is formed a latch portion 41 which extends downwardly and can be inserted into the securing hole 71 of the tongue plate 7 to thereby lock the tongue plate 7. In the two sides of the rear end portion of the latch plate 14, there are projectingly formed support portions 46B and 46C which can be rotatably supported by the support holes 35B and 35C of the side walls 12B and 12C respectively. That is, the latch plate 14 can be rotated with the support portions 46B and 46C as the fulcrums thereof to thereby move to the lock position or non-lock position of the tongue plate 7. In the substantially central portion of the rear end side of the opening 40, there is projectingly formed a spring support portion 42 by which the other end of the coiled spring 15 can be supported.

The block member 21 is disposed in order to withstand the pressure that can be applied from the upper cover 23 side of the buckle main body 11. The block member 21 includes two engagement portions (not shown) respectively formed in the two end portions thereof in the longitudinal direction of the buckle base 12; that is, the two engagement portions are engaged with the buckle base 12 so that the block member 21 is fixed to the buckle base 12. In the substantially central portion of the front end side of the block member 21, there is formed a spring support portion 43 by which one end of the coiled spring 19 can be supported.

The release button 18 includes an operation portion 55 having a substantially U-shaped section and two arms 56B and 56C which are respectively provided on the two sides of the operation portion 55 and extended horizontally toward the backward direction therefrom. In the substantially central portion of the inner surface of the operation portion 55, there is formed a spring support portion 57 for supporting the other end of the coiled spring 19. And, the release button 18 is always energized forwardly by the coiled spring 19.

Also, on the rear side of the operation portion 55, there is formed an inclined portion 58. This inclined portion 58, when the release button 18 is pushed into the interior portion of the buckle main body 11, pushes back the control pin 17.

The switch 20 includes a switch main body 60, a switch button 61 disposed on the outer wall of the switch main body 60, an actuator 54 used to operate the switch button 61, a skirt portion 62 formed integrally with the switch main body 60, and a harness 63 to be connected to the switch main body 60.

The actuator 54 is made of a springy plate-shaped member and, when it is pushed by the slider 13, can be shifted in position to thereby operate the switch button 61.

In the portion of the skirt portion 62 that is present on the rear side of the buckle base 12, there are formed a groove 64 in which the harness 63 is disposed (guided), and a guide portion 65 which not only defines the groove 64 but also guides the harness 63.

The groove 64, as shown especially in FIG. 8, is open on the lower side thereof (on the side of the lower cover 22). In the vicinity of the harness exit of the guide portion 65, there is formed a curved surface 66. Also, in the middle portion of the groove 64, there is provided a small projection 67 which projects inwardly of the groove 64 and serves as a hold portion for holding the harness 63. The groove 64, guide portion 65 and small projection 67 are disposed at such positions as to allow the harness 63 to be arranged in a direction substantially at right angle (substantially perpendicular) to a direction in which the harness 63 is pulled out from the buckle main body 11. Since the groove 64, guide portion 65 and small projection 67 are disposed in this manner, even in case where the harness 63 is pulled unexpectedly, the load to be applied to the switch main body 60 can be reduced. Also, the existence of the curved surface 66 can prevent the harness 63 from being bent at an acute angle, thereby being able to relieve the concentration of stresses on the harness 63. Further, because the width of the groove 64 can be made slightly finer than the diameter of the harness 63 due to the small projection 67, the harness 63 can be prevented from shifting out of the groove 64. Therefore, the harness 63 can be fixed to the switch 20 positively. Due to this, the arrangement (guide) position of the harness 63 in the interior of the buckle main body 11 can be restricted before the lower and upper covers 22 and 23 are assembled together, which makes it easy to determine the shape of a buckle base support rib 73 (which will be discussed later) disposed in the interior of the lower cover 22. Accordingly, when assembling together the two covers 22 and 23, the harness 63 can be prevented from being caught by and between the two covers 22 and 23. Also, since the harness 63 is fixed to the anchor plate 10 by a fixing band 68 outside the buckle main body 11, when the harness 63 is pulled unexpectedly, the load to be applied to the switch main body 60 can be reduced further.

Also, in the skirt portion 62, there is formed a hole 74 into which the rivet 24 for fixing the switch 20 to the bottom surface 12A of the buckle base 12 can be inserted. Further, in the skirt portion 62, there is also formed a boss 51 which can be inserted into the hole 52 formed in the bottom surface 12A of the buckle base 12.

To fix the switch 20 to the buckle base 12, after the boss 51 is inserted into the hole 52 of the bottom surface 12A, the rivet 24 may be penetrated through the hole 74 of the switch 20 and also through the hole 53 of the bottom surface 12A, and the portion of the rivet 24 that projects from the bottom surface 12A may be caulked. In this manner, the switch 20 is fixed to the metal-made buckle base 12 using the rivet 24 and, therefore, the fixed position of the switch 20 can be prevented from varying and also the given position of the switch 20 can be kept positively. Also, in the buckle base 12, there may be only formed the simple hole 53 into which the rivet 24 can be inserted; that is, the step of working the buckle base 12 is simple.

On/off signals from the switch 20 are transmitted to, for example, a control part (which is not shown). The control part, based on the on/off signals transmitted thereto, turns on, for example, an unworn seat belt warning display lamp in a seat belt wearing confirmation display part provided on a panel in front of a driver's seat.

By the way, the material and type of the rivet 24 are not limited but, in the embodiment 1, there is used a blind rivet which is formed of aluminum. A blind rivet can be caulked from one direction and a load necessary for caulking can also be made stable. And, use of the aluminum-made blind rivet can also reduce the compressive load that is applied to the switch 20. Further, provided that there can be secured on the caulking side a small space for allowing the rivet 24 to project, the switch 20 can be fixed to any portion simply.

In the substantially central portion of the lower cover 22, there are formed two walls 81B and 81C (see FIG. 6) which are erected in parallel to the tongue plate inserting and removing direction and are used to define a storage portion 80 for storing the slider 13 slidably. Also, on the rear side of the lower cover 22, there is formed a switch and harness escape portion 82 (the area of which is shown by oblique check patterns in FIG. 6).

Now, the upper cover 23 is disposed on the upper portion of the lower cover 22 the composing parts of which have been assembled in the above-mentioned manner. The upper cover 23 includes an opening 83 which is formed in the front end portion of the buckle base 12 and into which the operation portion 55 of the release button 18 can be extended advanceably and retreatably. This opening 83 has a size which can form a clearance between the lower surface of the release button 18 and itself; and, this clearance provides a tongue plate inserting and removing opening 84.

Next, description will be given below of the concrete operation of the seat belt apparatus according to the embodiment 1.

To lock the tongue plate 7 to the buckle main body 11, firstly, the tongue plate 7 may be inserted into the buckle main body 11 from the tongue plate inserting and removing opening 84. At the then time, the leading end of the tongue plate 7 is contacted with the contact surface 28 of the slider 13 to thereby move the slider 13 into the interior of the buckle base 12. With this movement of the slider 13, the buckle arm 16 is rotated counterclockwise to thereby push and compress the coiled spring 15 against the spring support portion 42.

Because of the compressive movement of the coiled spring 15, not only the latch plate 14 is energized and pushed up by the coiled spring 15 but also the support portion 49 moves the control pin 17 in a direction where the latch plate 14 can be held at the tongue plate lock position. This movement of the control pin 17 is carried out by the movements of the two end portions of the control pin 17 through the interiors of the substantially L-shaped windows 33B and 33C. Specifically, the two end portions of the control pin 17, firstly, move vertically along the L shapes of the windows 33B and 33C. Next, the two end portions of the control pin 17 pass through the corner portions of the windows 33B and 33C, move horizontally and stop at the above-mentioned securing positions to thereby be able to hold the upper surface of the latch plate in the vicinity of the latch portion 41. At the then time, since the control pin 17 is locked by the horizontal upper edges of the windows 33B and 33C so as not to move upwardly, the latch plate 14 can be secured positively.

By the way, when the control pin 17 moves, it is contacted with the edges of the windows 33B and 33C in a line contact manner, which can reduce the frictional forces that are produced during the movement of the control pin 17. Also, since the substantially central portion of the control pin 17 is supported by the support portion 49, the two sides of the control pin 17 are always operated similarly; for example, when only one side of the control pin 17 advances and retreats, it is possible to prevent the occurrence of an unfavorable operation which generates a pseudo-latch phenomenon.

Also, due to the movement of the slider 13, the operation foot portion 29 presses against the actuator 54 of the switch 20. This shifts the actuator 54 to thereby operate the switch button 61 (for example, the switch button 61 is turned on). As a result of this, an on signal is transmitted to a control part (not shown) and, in accordance with the on signal, the control part turns off, for example, an unworn seat belt warning display lamp in the seat belt wearing confirmation display part disposed on the panel in front of a driver's seat, thereby showing that the seat belt has been worn.

Thanks to the above series of operations, the latch portion 41 is inserted into the securing hole 71 of the tongue plate 7, so that the tongue plate 7 can be locked to the buckle main body 11 (see FIGS. 4 and 5).

Next, to remove the tongue plate 7 from the buckle main body 11, the release button 18 may be pushed into the interior of the buckle main body 12, and the control pin 17 may be pushed back by the inclined portion 58 of the release button 18 to thereby remove the locked condition of the latch plate 14.

In case where the tongue plate 7 is removed in this manner, due to the energizing force of the coiled spring 15, the buckle arm 16 is rotated clockwise and, with the rotation of the buckle arm 16, the slider 13 is returned to its original position, that is, to the front end side of the buckle base 12. The movement of the slider 13 causes the operation foot portion 29 to move away from the actuator 54 of the switch 20, thereby turning off the switch 20. An off signal showing the off state of the switch 20 is transmitted to the control part (not shown) and, based on the off signal, the control part, for example, displays, in the above-mentioned seat belt wearing confirmation display part (not shown), a warning showing that the seat belt is not worn.

Also, simultaneously with this operation, the control pin 17 and latch plate 14 are also returned to their respective original positions (see FIGS. 2 and 3).

By the way, in the embodiment 1, description has been given of a case where the groove 64, guide portion 65 and small projection 67 are disposed at positions where the harness 63 can be arranged in a direction substantially at right angle (substantially perpendicular) to a direction in which the harness 63 is pulled out from the buckle main body 11. However, this is not limitative but the positions of the groove 64, guide portion 65 and small projection 67 are not limited to the substantially right angle, provided that they are disposed in the range where any load can be prevented from being applied to the switch main body 60 when the harness 63 is pulled unexpectedly.

Embodiment 2

Next, description will be given below of a seat belt apparatus according to an embodiment 2 of the invention with reference to the accompanying drawings.

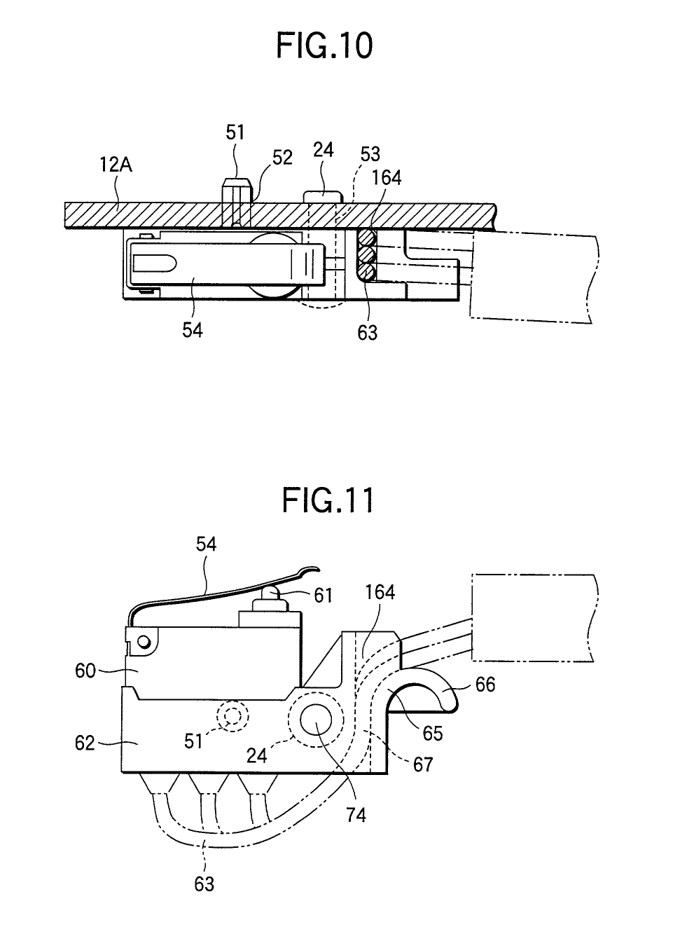

Now, FIG. 10 is a section view of the neighboring portions of a switch used in a seat belt apparatus according to the embodiment 2 of the invention, and FIG. 11 is a bottom view of FIG. 10. By the way, in the embodiment 2, like parts as in the seat belt apparatus according to the previously described embodiment 1 are given the same designations and thus the detailed description thereof is omitted here.

The seat belt apparatus according to the embodiment 2 is different from the seatbelt apparatus according to the embodiment 1 in the shape of a groove 164 formed in the skirt portion 62 of the switch 20.

That is, in the case of the groove 164 according to the embodiment 2, as shown especially in FIG. 10, on the bottom surface 12A side thereof, there is formed an opening. According to this structure, since the opening of the groove 164 is positively closed by the bottom surface 12A, there is no possibility that the harness 63 can float up from the groove 164 or can be removed therefrom.

Embodiment 3

Next, description will be given below of a seat belt apparatus according to an embodiment 3 of the invention with reference to the accompanying drawings.

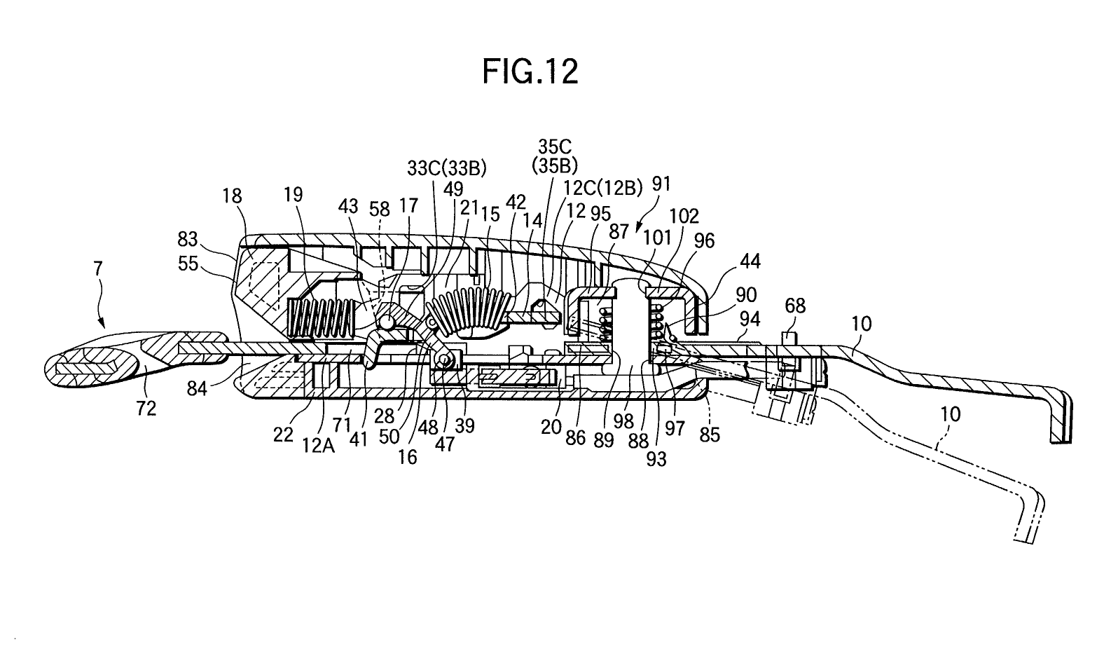

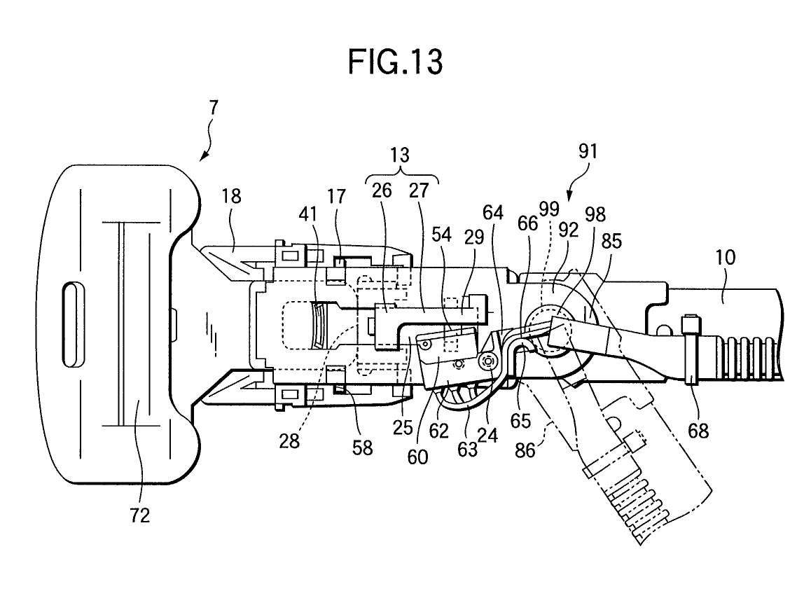

Now, FIG. 12 is a longitudinal section view of a buckle device applied to the seat belt apparatus according to the embodiment 3 of the invention, showing a state in which a tongue plate is inserted, and FIG. 13 is a bottom view of the buckle device shown in FIG. 12.

By the way, in the embodiment 3, like parts as in the seat belt apparatus according to the previously described embodiment 1 are given the same designations and thus the detailed description thereof is omitted here.

The seat belt apparatus according to the embodiment 3 is different from the seat belt apparatus according to the embodiment 1 in that, as shown in FIGS. 12 and 13, a buckle main body 91 is disposed so as to be rotatable with respect to the anchor plate 10 in the longitudinal direction and width direction of a vehicle.

That is, the buckle main body 91 according to the embodiment 3 comprises: a mold 94 to be fitted into a circular hole 93 formed in the rear end portion of the buckle base 12; a rotation restrictive member 95 for restricting the rotation of the buckle main body 91, which is formed in one end portion of the anchor plate 10, with respect to the anchor plate 10 in the longitudinal direction and width direction of a vehicle; a coiled spring 96 having one end fixed to the mold 94 with the other end fixed to the rotation restrictive member 95; a mold 97 interposed between the buckle base 12 and anchor plate 10 for allowing the rotation of the buckle main body 91 to be executed smoothly; and, a rivet 98 to be inserted into the above-mentioned composing parts of the buckle main body 91.

In the rear end portion of the buckle base 12, there is formed a circular portion 92 and, in the substantially central portion of the circular portion 92, there is formed a circular hole 99. Also, in the end portion of the circular portion 92, there is formed an inclined surface 85 which is inclined downwardly at an angle of about 15°.

The anchor plate 10 is made of rigid metal into a narrow and long plate as a whole. On the rivet 98 side in the longitudinal direction of the anchor plate 10, there is formed a circular portion 86 and, in the circular portion 86, there is formed a circular hole 93 into which the mold 94 (which will be discussed later in detail) can be fitted. In the circular portion 86, as will be discussed later in detail, there is provided a projecting portion (not shown) which, when the buckle main body 91 is rotated counterclockwise, can be contacted with the end portion of the rotation restrictive portion 87 of the rotation restrictive member 95 to thereby prevent the buckle main body 91 from rotating any further. In the vicinity of the circular portion 86 of the anchor plate 10, as will be discussed later in detail, there is provided a projecting portion (not shown) which can be contacted with the end portion of the rotation restrictive portion 87 to thereby prevent the buckle main body 1 from rotating clockwise.

In the substantially central portion of the mold 94, there is formed a boss portion 88 which can be fitted into the circular hole 93 of the anchor plate 10. In the interior portion of the boss portion 88, there is formed an elongated hole having an inclined surface 89 which is used to rotate the buckle main body 91 in the width direction of the vehicle. Also, in the mold 94, there is formed a fixing portion 90 to which one end of the coiled spring 96 (the details of which will be discussed later) can be fixed.

The rotation restrictive member 95 includes the rotation restrictive portion 87 which is disposed erect downwardly along part of the outer periphery of a substantially circular portion 102 having a circular hole 101 formed in the substantially central portion thereof. On the opposed side to the rotation restrictive portion 87, there is formed a spring cover portion 44 which is disposed erect downwardly along the substantially circular portion 102. The thus structured rotation restrictive member 95 is fixed to the buckle base 12 by the rivet 98 in such a manner that it can maintain this arrangement.

The rotation restrictive portion 87 is structured such that one end portion of its extension portion extended downwardly can be contacted with the above-mentioned projecting portion formed in the anchor plate 10 to thereby prevent the buckle main body 91 from rotating clockwise. In this state, the rotation of the buckle main body 91 in the vehicle width direction (in FIG. 12, when the anchor plate 10 is fixed, the rotation of the buckle main body 91 around the rivet 98 in the vertical direction in FIG. 12) is considered possible. Also, the other end portion of the above extension portion is structured such that, when the buckle main body 91 is rotated counterclockwise, it can be contacted with the other projecting portion formed in the anchor plate 10 to thereby prevent any further counterclockwise rotation of the buckle main body 91. And, when the buckle main body 91 is going to rotate in the vehicle width direction in the contacted state of the other end portion of the extension portion with the other projecting portion, the rotation restrictive portion 87 is contacted with the upper surface of the above projecting portion formed in the anchor plate 10 to thereby prevent the rotation of the buckle main body 91 in the vehicle width direction.

One end of the coiled spring 96 is fixed to the fixing portion of the mold 94 and the other end thereof is fixed to the rotation restrictive member 95; and thus, the coil spring 95 is always energizing the buckle main body 91 clockwise.

The rivet 98 is inserted into the circular hole 99 from the back side of the buckle base 12. The rivet 98 is penetrated through the buckle base 12, spacer 97, the circular hole 93 of the anchor plate 10, the elongated hole of the mold 94, and coiled spring 16 to thereby support these parts on the buckle base 12; and further, they are inserted through the circular hole 101 of the rotation restrictive member 95 and are thereby fixed to the rotation restrictive member 95 as an integral body.

The buckle device having the above structure can be inclined and rotated within predetermined directions and ranges in the connecting portion thereof with the anchor plate 10 for mounting the buckle main body 91 onto the vehicle. Therefore, when an occupant 3 wears a seat belt, the buckle main body 91 can be inclined toward the occupant 3 side and thus the seat belt can be made to fit the occupant 3. Also, in case where, in a vehicle collision, the buckle is pulled forwardly beyond the seat belt, the buckle device can follow the buckle in the pulling direction and the buckle main body can be rotated. Further, in case where, while the vehicle is running, due to collision of the vehicle, the buckle main body 91 is contacted with the occupant 3 or baggage, the buckle main body 91 is rotated with respect to the anchor plate 10 to thereby be able to escape into between the seat 2 and a console (that is, into a state where it is stored).

In the case of a conventional rotation-type (oscillation-type) buckle device, normally, the position, angle of bending and the curvature of bending of the harness 63 of the switch 20 cannot be set definite but, under the low temperature conditions, there is a high possibility that the harness 63 can be broken; and, therefore, conventionally, there have been required some devices in the arrangement (guidance) of the harness 63. On the other hand, however, in the case of the buckle device according to the embodiment 3 of the invention, since the bending position and bending angle of the harness 63 can be set definite due to the guide portion 65 of the skirt portion 62 formed integrally with the switch 20, in both of a buckle device for a right seat and a buckle device for a left seat which are different in the rotation direction, the bending angle can be set similarly.

Also, because the exit of the harness 63 is composed of the large curved surface 66, the bending position of the harness 63 can be made definite and the curvature of bending can be increased, thereby being able to relieve the concentration of stresses.

By the way, the switch structure according to the invention is not limited to the buckle devices described in the embodiments 1-3 but, of course, it can also be applied to a buckle device having the other structure.

As has been described heretofore, since a seat belt apparatus according to the invention has the structure that the switch for detecting the engaged and removed states of the tongue plate is fixed to the buckle base by the rivet, the switch can be prevented from varying in position due to heat or due to the change with age of its material. Also, because the switch is fixed by the rivet, in the buckle base, there may be only formed a simple hole into which the rivet can be inserted. This makes it possible to provide a seat belt apparatus including a highly reliable buckle device which is simple to work and assemble and is able to hold the switch at its given position positively.

Further, since the switch comprises a hold portion for holding a harness and a guide portion for guiding the harness, the guidance (arrangement) of the harness can be restricted before the buckle covers are assembled together. Thanks to this, when assembling together the upper and lower covers, the harness can never be caught by and between the covers, which makes it possible to provide a seat belt apparatus including a buckle device having a highly reliable switch mounting structure.

Moreover, even in case where the buckle main body can be rotated with respect to the anchor plate in the longitudinal and width directions of a vehicle, the concentration of stresses on the harness can be relieved.

What is claimed is:

1. A seat belt apparatus, comprising:
a tongue plate;
a buckle base into which said tongue plate can be removably inserted and also which removably locks said tongue plate inserted thereinto; and,
a switch disposed on said buckle base for detecting the engaged and removed states of said tongue plate,
wherein said switch is fixed to said buckle base by a rivet.

2. The seat belt apparatus as set forth in claim 1, wherein said rivet is a blind rivet.

3. The seat belt apparatus as set forth in claim 1, wherein said rivet is made of aluminum.

4. The seat belt apparatus as set forth in claim 1, wherein said switch comprises a hold portion for holding a harness of said switch and a guide portion for guiding said harness.

5. The seat belt apparatus as set forth in claim 4, wherein said hold portion and said guide portion are disposed at such positions as to allow said harness to be arranged at a given angle with respect to the pull-out direction of said harness from said buckle device.

6. The seat belt apparatus as set forth in claim 5, wherein the given angle is substantially right angle to the pull-out direction of said harness from said buckle device.

7. The seat belt apparatus as set forth in claim 4, wherein said guide portion is disposed in the vicinity of an exit for the harness of said buckle base and includes a curved surface.

8. A seat belt apparatus, comprising:
a tongue plate;
a buckle base into which said tongue plate can be removably inserted and also which removably locks said tongue plate inserted thereinto; and,
a switch disposed on said buckle base for detecting the engaged and removed states of said tongue plate,
wherein said switch comprises a hold portion for holding a harness of said switch and a guide portion for guiding said harness.

9. The seat belt apparatus as set forth in claim 8, wherein said hold portion and said guide portion are disposed at such positions as to allow said harness to be arranged at a given angle with respect to the pull-out direction of said harness from said buckle device.

10. The seat belt apparatus as set forth in claim 9, wherein the given angle is substantially right angle to the pull-out direction of said harness from said buckle device.

11. The seat belt apparatus as set forth in any one of claims 8 to 10, wherein said guide portion is disposed in the vicinity of an exit for the harness of said buckle base and includes a curved surface.

12. A seat belt apparatus, comprising:
a tongue plate;
a buckle base into which said tongue plate can be removably inserted and also which removably locks said tongue plate inserted thereinto; and,
a switch disposed on said buckle base for detecting the engaged and removed states of said tongue plate,
wherein said switch is fixed to said buckle base by a rivet and said buckle device is mounted through a buckle stay on a vehicle rotated with respect to said buckle stay in the longitudinal direction and width direction of said vehicle.

13. A seat belt apparatus, comprising:
a tongue plate;
a buckle base into which said tongue plate can be removably inserted and also which removably locks said tongue plate inserted thereinto; and,
a switch disposed on said buckle base for detecting the engaged and removed states of said tongue plate,
wherein said switch comprises a hold portion for holding a harness of said switch and a guide portion for guiding said harness and said buckle device is mounted through a buckle stay on a vehicle rotated with respect to said buckle stay in the longitudinal direction and width direction of said vehicle.
